(19) United States
(12) Patent Application Publication
(10) Pub. No.: US 2018/0232757 A1
(43) Pub. Date: Aug. 16, 2018

(54) SYSTEM AND METHOD FOR INCENTIVIZED SALE AND PURCHASE OF QUANTITY BASED CONSUMER GOODS AT MULTIPLE PURCHASE OPPORTUNITIES OVER EXTENDED PERIOD OF TIME

(71) Applicant: Benjamin J. LEFFELMAN, Sugar Grove, IL (US)

(72) Inventor: Benjamin J. LEFFELMAN, Sugar Grove, IL (US)

(21) Appl. No.: 15/516,431

(22) PCT Filed: Oct. 5, 2015
(86) PCT No.: PCT/US2015/054025

§ 371 Date: Apr. 3, 2017

Related U.S. Application Data
(60) Provisional application No. 62/059,572, filed on Oct. 3, 2014.

(51) Int. Cl. G06Q 30/02; G06K 7/14

(52) U.S. Cl. CPC G06Q 30/0238; G06F 17/30312; G06Q 30/0221; G06K 7/1417

(57) ABSTRACT

A computerized method and system for incentivized sale and purchase of quantity based consumer goods at multiple purchase opportunities over extended period of time is disclosed. The method comprises transmitting an offer to a consumer device, the offer comprising an item, price per item, a quantity, and a duration, selling, through the consumer device, the offer to a consumer, storing the consumer and the offer in a database, uniquely identifying the consumer through the consumer device at a point of sale, exchanging a number of the item with the consumer at the point of sale at the price per item, the number being less than or equal to the quantity, reducing the quantity associated with the offer in the database by the number to a remaining quantity, and honoring the offer at the point of sale for the duration at the remaining quantity.

### PRIORITY

The present application claims priority to and the benefit of U.S. Provisional Patent Application No. 62/059,572 filed on Oct. 3, 2014 which is incorporated by reference in its entirety.

### BACKGROUND

Consumers increasingly expect brands to offer incentives to remain loyal. Whether it be free shipping through Amazon Prime, rewards points offerings, and the like, consumers want a reason to continue shopping with one vendor over another.

Additionally, brick and mortar stores desire to entice consumers to enter the store to purchase products. These stores offer coupons, weekly sale advertisements, and are placed in areas to try to increase overall foot traffic. Advertisements and sale opportunities help drive consumers to stores where they will purchase full-price items in addition to the advertised and on-sale items.

Today, stores attack these two consumer desires independently, with rewards and incentive programs largely disparate from coupons. When there is overlap, the overlap usually is in the form of enabling a consumer to achieve a lower price point for a single visit or a single item based on the consumer being a member of a special rewards program. For example, clothing vendors will send coupons via email to customers advertising a one-time use coupon for a percentage off a single purchase.

Price clearly is a differentiator for consumers. Consumers may visit one store over another if they know that prices are lower. Some businesses have created entire business models on reducing in-store prices by offering bulk sizes or large quantities, like Sams and Costco.

Stores could combine all of these disparate marketing concepts to offer quantity-and-time-based coupons or price discounts which enable a consumer to purchase a certain quantity of items over a period of time. Unlike current offerings where a multiple quantity must be purchased over a limited time (and often on one visit), this program would allow the consumer to visit the store multiple times to get the full value of the price discount. For example, assume a merchant offers a gallon of milk for $1.00 off the regular price, with a maximum purchase of five gallons of milk (at the reduced price) over a five-week period. The invention is a tracking system which will be implemented at the point of sale to register the consumer and the consumer's initial purchase, and log in the remaining number of units that can be purchased at the sale price over an extended period of time. The invention will also allow the consumer to monitor the remaining number of units which remain to be purchased at the discount price for the time period, and the store where those products are available. Such an approach will increase foot traffic to the store like a general coupon, increase brand loyalty by requiring the consumer to visit the same store multiple times to take full advantage of the coupon, and offer a lower price to the consumer.

Accordingly, there exists a need for a tracking system and method for incentivized sales of consumer goods for multiple purchases over an extended period of time. There currently is no such tracking system available.

### BRIEF DESCRIPTION OF THE DRAWINGS

FIG. 1 illustrates a flowchart of a method for incentivized sales of consumer goods at multiple purchase opportunities over an extended period of time according to at least one embodiment of the present disclosure,

FIG. 2A displays the architecture of a system for incentivized sales of consumer goods at multiple purchase opportunities over an extended period of time according to at least one embodiment of the present disclosure.

FIG. 2B displays the architecture of a system for incentivized sales of consumer goods at multiple purchase opportunities over an extended period of time according to at least one embodiment of the present disclosure.

FIG. 2C displays the architecture of a system for incentivized sales of consumer goods at multiple purchase opportunities over an extended period of time according to at least one embodiment of the present disclosure.

FIG. 3A displays a screenshot of a user interface presented in association with a system and/or method for incentivized sales of consumer goods at multiple purchase opportunities over an extended period of time according to at least one embodiment of the present disclosure.

FIG. 3B displays a screenshot of a user interface presented in association with a system and/or method for incentivized sales of consumer goods at multiple purchase opportunities over an extended period of time according to at least one embodiment of the present disclosure.

FIG. 3C displays a screenshot of a user interface presented in association with a system and/or method for incentivized sales of consumer goods at multiple purchase opportunities over an extended period of time according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in languages such as Ruby, PHP, Perl, ASP.net, Java, HTML, HTML5, CSS3, Bootstrap, Python, C++, C#, Javascript, the Spring Framework, Node.js, Express, Underscore, Require, Backbone, Marionette, Handlebars, Mustache, Jquery, Modernizr, Sass, Compass, Angular, Scala, and/or the Go programming language. It should be appreciated, of course, that one of skill in the art will appreciate that other language may be used instead, or in combination with the foregoing and that web and/or mobile application frameworks may also be used, such as, for example, Ruby on Rails, Jo, Twitter bootstrap, and others.

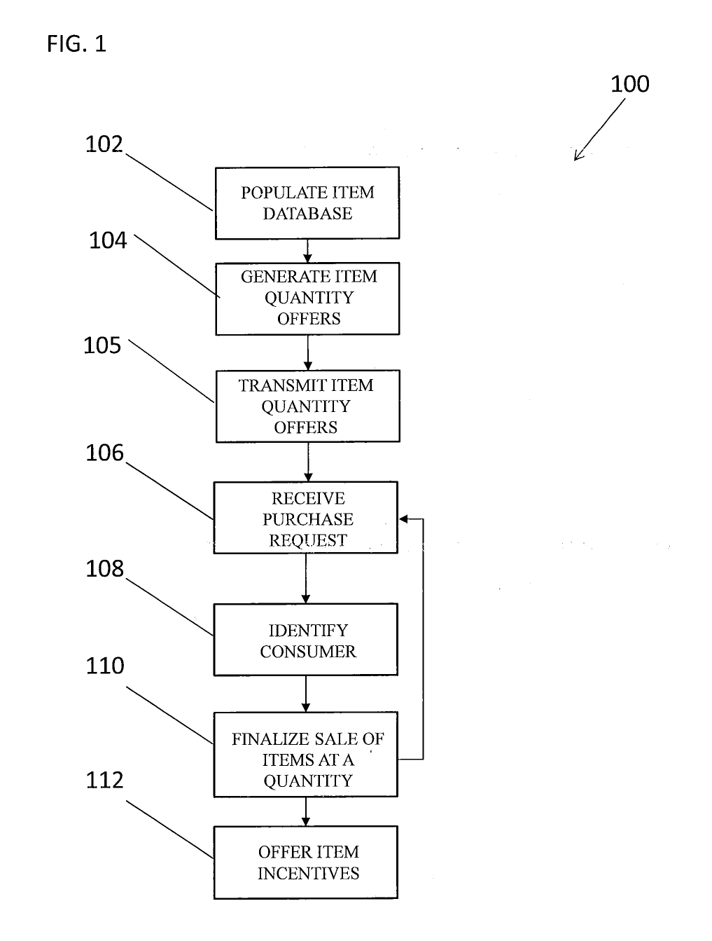

Referring now to FIG. 1, it is shown a method 100 for incentivized sales of consumer goods at multiple purchase opportunities over an extended period of time. As shown in FIG. 1, the method 100 includes populating an item database in step 102, generating item quantity offers in step 104, transmitting item quantity offers in step 105, receiving a purchase request in step 106, identifying a consumer in step 108, finalizing a sale of items at a quantity in step 110, and offering item incentives in step 112. As shown in the method 100, steps 106, 108, and 110 may create a loop such that these steps are repeated for multiple purchases of an item.

In at least one embodiment of the present disclosure, the method 100 includes populating an item database in step 102. In such an embodiment, item descriptions, unique identifiers (i.e. UPC, etc.), cost, price, time period where the product will be on sale, total number of those products that may be purchased over the established period of time, and other attributes are inserted into a database in step 102. In such an embodiment, the database may contain information related to items that will be offered for sale at multiple times over a period of time to consumers as further described herein. The database may be a relational database and available over a computer network, such as, for example, the Internet.

In some embodiments, the method 100 may use a pre-existing database of items offered for sale in a store. For example, many brick-and-mortar stores already have databases created which store inventory information, including pricing information, number of units available, purchase history, item descriptions, location in the store, and the like. It should be appreciated that the method 100 may utilize such a pre-existing database.

In at least one embodiment of the present disclosure, the method 100 includes generating item quantity offers in step 104. An item quantity offer may include, but is not limited to, an offer to a consumer for the purchase of an item at a certain quantity that is available for a period of time. These item quantity offers may be generated in step 104 using information stored in the item database.

As an example, a grocery store places a certain brand of milk in an item quantity sale for half price. Assume the non-sale price is four dollars per gallon. In step 104, the grocery store places the item for sale during a promotional period of three weeks for two dollars per gallon, with a limit of, for example, three gallons. In this example, a consumer probably is not interested in purchasing three gallons of milk at one time as the consumer's family may generally drink only one gallon per week, plus hauling three gallons of milk home is bulky, heavy, difficult to store, wasteful as the product will not be consumed prior to its expiration date. In addition, in this example, the consumer may also have budgetary constraints restricting the consumer's ability to purchase three gallons of milk at one time. Although, in this example, the pricing is attractive, the consumer has only so much they can afford to spend on groceries during a given week.

In this example, in step 104, the half price offer will be held open for three weeks, and the half price offer will be honored during that three-week period so long as the consumer returns once per week for two successive weeks to purchase the milk. The offer then, in this example, enables the consumer to purchase a total of three gallons of milk at a sale price of two dollars per gallon over a period of three weeks. The proposed system will track the number of such products purchased over this time period, and provide the consumer with information about the products which remain to be purchased prior to the deadline which was established by the merchant, along with the store location where those goods are available.

In another example, most stores offer quantity-based incentives to purchase 12-pack offerings of soda. Historically, if an offer for a 12-pack Mountain Dew said ‘4 for $12,’ a consumer did not have to actually purchase four 12-pack units to obtain the $3/unit price. When the consumer went to the register to purchase the 12-pack units, the register automatically calculated the price as $3/unit regardless of how many 12-pack units were purchased, but the opportunity to return at a future date to acquire additional 12-pack units at another time would be lost. Today, many stores require that consumers purchase the entirety of the offered quantity to receive the sale price.

Similar to the example with gallons of milk, 12-pack units of Mountain Dew are very heavy. Consumers walking to the store or with limited space in their cart may not be able to carry four 12-pack units, and, accordingly, cannot take advantage of the offer. On top of that, consumers generally cannot drink 48 cans of Mountain Dew in a short amount of time and, therefore, do not really have a need for four 12-pack units, plus the consumer may have budgetary constraints.

These ‘4 for $12’ offers, though, may only be offered for a limited time, sometimes only a single day. Currently, if a consumer wanted to purchase one 12-pack unit per week, which is in line with their budget, consumption, and ability to physically remove the items from the store, then the consumer will pay the non-sale price for each 12-pack unit which is purchased after the sale ends.

To improve this experience, in step 104, the ‘4 for $12’ offer could be offered as ‘4 for $12, good for 4 weeks’ which would enable a consumer to leave the store with one 12-pack unit at $3 and return each week for four weeks to purchase the remaining three 12-pack units. The system would track how many 12-pack units were purchased by that particular consumer, and allow the consumer to monitor both the number of remaining 12-pack units and the period of time whereby those units could be purchased at the sales price.

Item-based quantity offers may be searched by the user in step 104 at a mobile device through a mobile application. The mobile application may be configured to, based on user location obtained through GPS or other location services, populate a list of available stores in the area offering item-based quantity offers. The user may search for offers based on store and/or by type of item or item. For example, a user may search for “Doritos” in the mobile application and, based on the user's location, the mobile application may display a list of stores offering item-based quantity promotions for Doritos. Through the mobile application, the user may view other stores with promotions for the same item.

In step 104, the mobile application may also receive push alerts associated with items previously purchased by the user or new items that the user could purchase that may be desired by the user. These push notifications may be generated based on user buying habits, such as, for example, reminding a user that every month he or she purchases a promotion for multiple gallons of milk and it is time to purchase another promotion.

Push notifications may also be received at the mobile application when the user is in close proximity to desired items, such as, for example, by passing through a geo-fence, being near an iBeacon, or otherwise. In this example, a user may receive an indication that a store one block away is offering a promotion on the user's favorite item, Mountain Dew, with the opportunity to purchase six twelve packs at $4/pack good for four weeks. In another example, a user may receive a push notification when the user walks by an iBeacon at a store that tells the user bread is available at a promotion of, for example, six loaves of bread at $2/loaf good for four weeks, in a nearby aisle.

It should be appreciated that the consumer examples discussed above are not exhaustive. The method 100 may be executed with any variety of consumer goods and also business to business transactions. For example, a hospital uses intravenous (IV) bags frequently, but may not have enough data to predict how many IV bags will be used each month. Rather than waste hospital space to store a year's supply of IV bags when buying in bulk, the hospital may purchase a quantity-based offer for 10,000 IV bags, good for a year. In this example, the hospital may request additional IV bags under the quantity-based purchase when the amount of IV bags is running low at the hospital.

In addition, other items with volatile prices may be purchased through the method 100 that may not be found on store shelves. For example, the price of gas rises and falls periodically without predictability by the average consumer. A consumer that believes gas prices are relatively cheap for a period may desire to purchase the right to obtain many gallons of gas at one price over a period of time (i.e. 100 gallons of gas at $2.00/gallon good for six weeks). In this example, the item-based quantity offer may allow the user to fill up a gas tank at a guaranteed price over a period of time and up to the quantity of gallons purchased.

In step 105, item quantity offers may be transmitted or displayed to a consumer. In step 105, the offer may be presented to the consumer in a variety of ways, such as, for example, placing placards near items in a brick-and-mortar store, listing the offers on a webpage, or other ways.

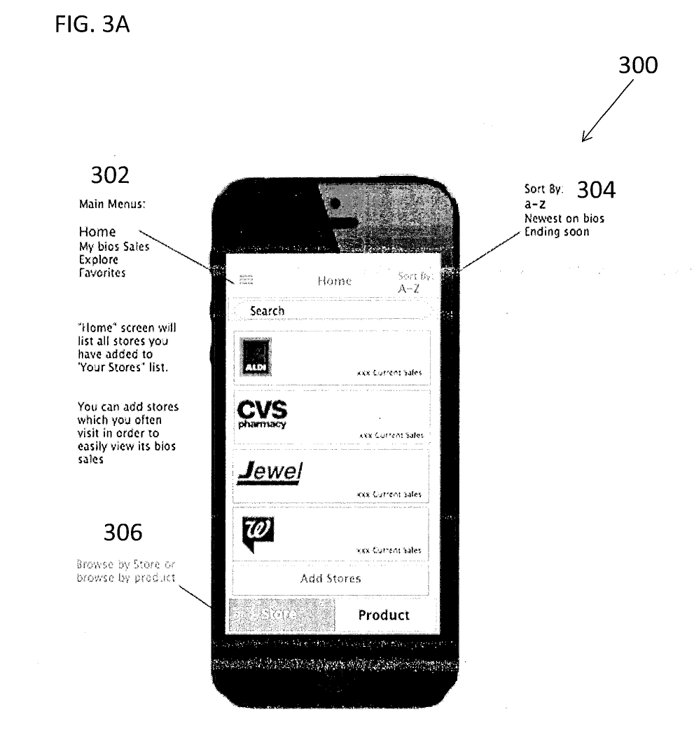

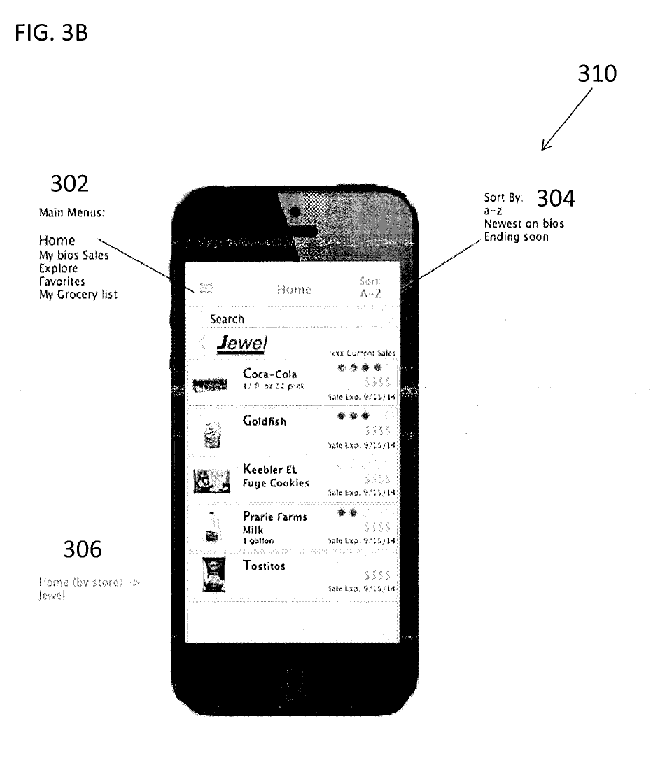

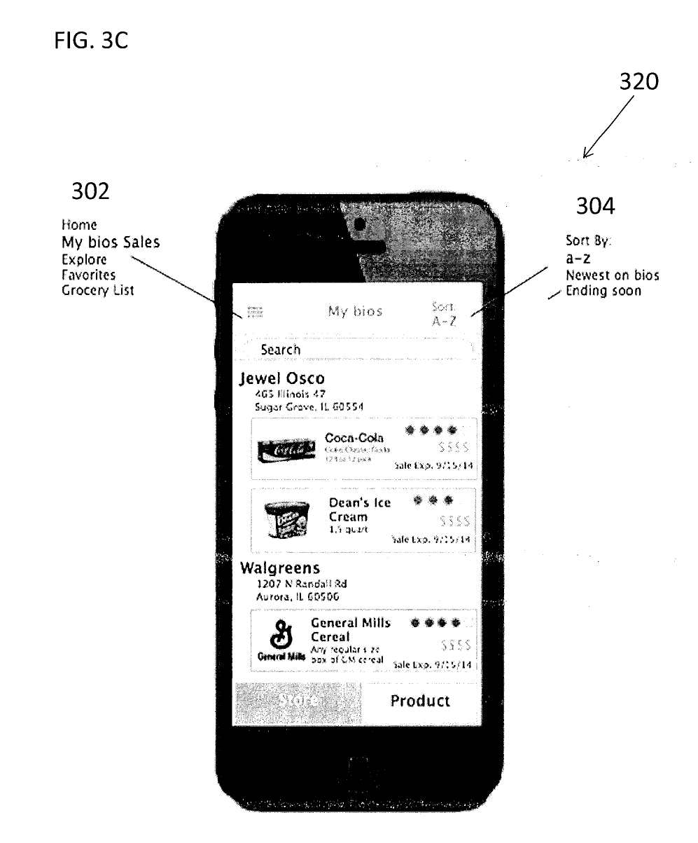

In a preferred embodiment, the offers may be made available to a consumer in a mobile application designed for quantity based item offers. The mobile application may enable a consumer to search for item quantity offers by product or store. In some embodiments, the mobile application may enable a user to find quantity based item offers close to the user via GPS. One example of graphical user interfaces for such a mobile application is shown in FIGS. 3A-3C. In step 105, in some embodiments, item quantity offers may be pushed to a mobile application when the mobile device passes through a geofence or is in close proximity to a beacon.

In step 106, a consumer may purchase an item through a quantity based item offer at a point of sale, such as, for example, a register at a physical store or over a computer network in a virtual store. Common points of sale systems used in the grocery industry include, for example, the following: IBM4690, IBM SA, ISS45, IT Retail, ACS.IR, LOC, and Scanmaster 1 & 2. In some embodiments, the item based quantity offer may be facilitated through a system integrated with the scanning software utilized at checkout. When the first purchased item is scanned the system will automatically “save” additional buying opportunities from the quantity based item offer for the consumer under the consumer's account with the system in step 108. The consumer's account may be triggered at time of payment either by the consumer's use of a personal identification number (a “PIN,” such as a phone number) at the time of checkout, by the consumer's use of a registered credit card number, by the consumer's unique bar code or QR code available on their smart phone or a smart card (“FOB”), or any other unique identifier any one of which can be scanned or entered at checkout. In step 110, the sale for the item is finalized at a quantity with the merchant system.

For example, a consumer enters a grocery store and loads a mobile application for quantity based item offers. Browsing the application, the consumer locates an offer for the purchase of up to 10 packages of paper towels containing 4 rolls each at $4.00 per package, good for twelve weeks. In this example, the consumer walks through the store and locates the paper towels with the offer. Not wanting to purchase all 10 packages of paper towels at once, the consumer places one package in his or her cart and proceeds to checkout.

At checkout, the package of paper towels is scanned for purchase and the consumer is uniquely identified in some way. In most scenarios, in the grocery context, the consumer has a rewards card or other grocery card and may be uniquely identified in that manner. In some scenarios, the consumer may uniquely identify himself or herself with a QR code from the mobile application, a credit card, an email address, a phone number, or others. After uniquely identifying himself or herself, a merchant system notes that the paper towels are available for quantity based item offers and activates the applicable offer for the user. In this example, the one package of paper towels purchased by the consumer is allocated in the system with the quantity based item offer. When the consumer returns to the store within the next twelve weeks, the consumer may receive the discount price from the quantity based item offer for the next nine package purchases of the paper towels. The time period can be modified as appropriate to match normal consumer buying habits. Paper towels, for example, may not be a product purchased on a weekly basis. In that case the time period can be lengthened to match realistic purchasing behavior.

Another example where quantity based item offers may be advantageous is clothing. A certain brand of blue jeans goes on sale in August as part of a going back to school promotion. The store promotes the jeans as being on sale at one-third off, limit 6 pair over a 90 day period. The shopper knows the price is attractive, but can only afford perhaps 4 pair currently. At the point of sale, the shopper is uniquely identified, his or her purchase is stored, and the shopper is allocated with an opportunity to return anytime in the next 90 days to acquire the remaining two pairs of jeans at the discount pricing.

The mobile application may integrate with a back-end merchant system or store management system over a computer network to retrieve, process, and display available offers, accepted offers by the consumer, and track the number of purchases made under any accepted offer by the consumer. In such an embodiment, the mobile application may uniquely identify the user through a variety of ways, such as, for example, the user's credit card information, a personal login (i.e. username or email address), a unique identifier for a smartphone where the application is loaded (i.e. iemi, Apple ID, etc.).

To track consumption of the item-based quantity offers by the user, a mobile application may display the number of remaining items available from a purchased promotion, a progress bar associated with the promotion, or push notifications to the user as quantity is retrieved by the user.

To facilitate the item quantity offers described herein, an entity may be required to at least maintain which offers have been made, keep track of available inventory to satisfy accepted offers, and maintain customer purchase information. In some embodiments, an entity may facilitate these requirements through a system which is installed at the merchant level and where the system then is equipped to track inventory, maintain offers, identify customers, track customer accepted offers, and track identified customer purchases.

Quantity-based item offers will provide future buying opportunities at sale pricing for the consumer, plus raise the consumer's brand awareness and loyalty to both the products being purchased and store where they are being purchased. For the merchant, the item-based quantity offers will promote store loyalty and increased store visits, plus provide meaningful data about the consumer's buying history and purchasing habits. The offers will provide accurate data as to the impact of promotional products since the data will be from actual sales via point of purchase. The data is also more meaningful to the manufacturer than traditional marketing data since it can be transmitted on a timely basis and be specific as to each retailer and that location.

Quantity-based item offers allow merchants to effectively compete against the “big box” stores that are able to offer low pricing if the consumer buys in bulk. Under the bulk purchase scenario, a consumer needs to purchase 24 rolls of paper towels in order to get the $1 per unit pricing, and spend $24 on one item—paper towels. With quantity-based item offers, the consumer can buy what he or she wants and needs—a package of 4 paper towels, and get the $1 per unit pricing, together with an opportunity to return 5 more times over the designated time period to acquire the other five packages of 4-per package at the $1 per unit price. This provides the advantage of not having to haul and store a 24 case package, plus it allows consumers the opportunity to enjoy the same price level offered by the “big box” stores and not come out of pocket for the entire $24 amount at one time. This in turn allows the consumer to purchase other products and stay within their budget, and it prompts the consumer to return to the store for that offered item, which is helpful to the merchant because it means foot traffic at different time periods, which in turn promotes the sale of other products while at that return visit.

In addition, marketers may realize benefits for great flexibility in creative promotions. For example, a “buy one, get one free” promotion, which only attracts the consumer for a one time visit, can be replaced with a promotion of “For the next two weeks, get 50% off” campaign. To the consumer it's the same total effect—two items at half the price. To the merchant, however, it is a return visit in order to capture the second item at the 50% off price, and this return visit has more value to the merchant because the second visit will also entail additional purchases.

Merchants can also use quantity-based item offers to promote certain in store brands, as compared to national brands. Since margins are generally greater for in store brands, offers will allow for greater flexibility and creativity for the pricing and time periods to which it will pertain. Likewise, a merchant can promote products that are unique to their store, such as the deli department, its bakery, or ready to eat meals.

The merchant can also use the offers for a loyalty rewards concept. The loyalty can be measured by number of store visits, with an award/reward being given for a certain number of visits or dollar spend within a given time. It can also be tied to the product then being promoted, under a “buy 4 within the next thirty days, and get the 5th one free” concept. The information could also be utilized by a merchant to develop individualized coupons or discounts in selected products.

The invention can also provide valuable information to the manufacturer. Under this arrangement the manufacturer would be made aware of the loyalty of a consumer to their products, and the impact of this new buying opportunity for its products. Promotions could be offered to the consumer by notifying them of an opportunity to take advantage of special pricing coupons available only to loyal customers, with the discounted pricing being taken at checkout.

The integration with the quantity-based item offers with a merchant system and/or mobile application will also provide information to the consumer on an easy to search basis by either product or store. The consumer can either pull up the information or search for remaining quantity-based item offers under either the name of the product (either generally or specifically by brand) or by the name of the store they wish to visit. All remaining purchasing opportunities will be listed under a given search. If the consumer selects a certain store then all current opportunities will be mentioned. An example of such a graphical user interface is shown in FIGS. 3A-3C.

The consumer can also search for a quantity-based item offer by searching for the product (either generally or by brand name). The current offers for that product will then appear and the consumer can select which store to visit in order to get that offer.

A GPS enabled feature may allow the consumer to receive notification of all quantity-based item offers—both those currently reserved for that consumer, plus those currently being promoted, as soon as the consumer enters the store.

As shown in FIG. 1, the method 100 includes offering item incentives at step 112. It should be appreciated that the quantity-based item offers discussed in the method 100 create unique marketing opportunities for consumers to interact with retailers and other providers.

Item incentivizes may take a variety of forms under the quantity-based offer incentive methods discussed herein. For example, a user purchasing a quantity-based item offer may be incentivized in step 112 to purchase an additional quantity of goods after exhaustion of the purchased offer. In one example, a user may purchase a quantity-based item offer for four 12-packs of Mountain Dew at $4/pack, good for four weeks. After receipt of the fourth 12-pack of Mountain Dew in step 110, step 112 may generate an item incentive to the user for a fifth 12-pack of Mountain Dew at the original $4/pack purchase price. Other item incentives may be performed, such as, for example, offering that the user repeat the purchase of the four 12-packs of Mountain Dew at $4/pack, good for four weeks promotion.

The item incentive in step 112 may also be a special gift offered to the consumer for a coupon of the items consumed for a later date or a special bonus gift for purchasing the promotion and consuming all of the goods in the promotion. For example, after obtaining the four 12-packs over the time period, an incentive may be pushed to the user in step 112 in the form of a free 20 oz. special flavor of Mountain Dew for the consumer to try.

In addition, at step 112, the incentive may be associated with an item that is related to the original item being purchased. In the Mountain Dew example above, the user may be offered to purchase a promotion for six bags of Doritos Cooler Ranch chips at $1/bag, good for four weeks to complement the user's purchase of multiple Mountain Dew 12-packs. In this example, a user may desire to consumer Mountain Dew and Doritos at the same time and, accordingly, an incentive to purchase the Doritos chips may be pushed to the user in step 112.

In another example, a user may be given an incentive in step 112 to return to the same store multiple times over a period. With purchase information and geo-location information stored within a mobile application or directly tied to the user at the time of purchase, the store may be able to determine how many times the user has visited the store in a given time period. In this example, in step 112, the user may be given a coupon to visit the store and purchase items a number of times within a set number of days or weeks (i.e. $10/off if you purchase one item at the store four different times over the next four weeks). This incentive may be offered in step 112 for a specific brand rather than a specific store (i.e. $10/off Doritos chips when you purchase four bags of Doritos chips four times different times over the next four weeks). It should be appreciated that this example may be tied to a specific purchase of brands at one store but also may be applied to purchases of that brand over multiple stores equipped to handle item-based quantity offers under the method 100.

Incentives offered at step 112 may further include point-based offers based on number of purchases, cost of purchases, and/or number of visits. To promote loyalty, the method 100 may track cost of items, number of items, and number of visits after each item purchase. In this embodiment, incentives offered at step 112 may be tied to a points system based on the offers (i.e. each dollar, visit, and item purchased is one point; 100 points generates a $5 coupon).

Incentives offered at step 112 may also be for a consumer to exchange purchased item-based quantity offers for other item-based quantity offers. For example, if a user purchases a right to obtain four 12-packs of Mountain Dew at $4/pack over four weeks, an incentive may be offered to the user to exchange that right for six 12-packs of Vitamin Water over four weeks. This incentive could be driven by asking the user to be more health conscious, based on available inventory at the retail location (i.e. excess available Vitamin Water and shortage of Mountain Dew), or other statistics.

Incentives offered at step 112 may further be related to manufacturer coupons. For example, a consumer purchasing an item-based quantity offer for six 8-packs of Scott toilet paper at $6/pack good for four weeks may be incentivized in step 112 to purchase additional Scott products, like Scott's paper towels. It should be appreciated that the coupons and other incentives offered in step 112 may not be related to the merchant where the offer may be redeemed, but, instead, be related to the manufacturer of the goods associated with the offer. These merchant incentives create additional opportunities for brand loyalty for the consumer.

Execution of the method 100 may create opportunities for a secondary market of item-based quantity offers purchased by consumers. Consumer A, with a purchase of three 12-packs of Mountain Dew at $4/pack over a four week period, may decide to exchange this purchase with Consumer B for Consumer B's purchase of six 8-packs of hot dog buns at $1/pack over a four week period. In this example, the users may exchange promotion purchases through a system either directly or for an exchange of additional compensation, and the like. It should be appreciated that the system may further support exchange of item-based quantity offers purchased by consumers when a portion of the offer has already been executed (i.e. Consumer A may sell the opportunity to purchase three 12-packs of Mountain Dew at $4/pack over a four week period with only two weeks left and after Consumer A has already received one 12-pack).

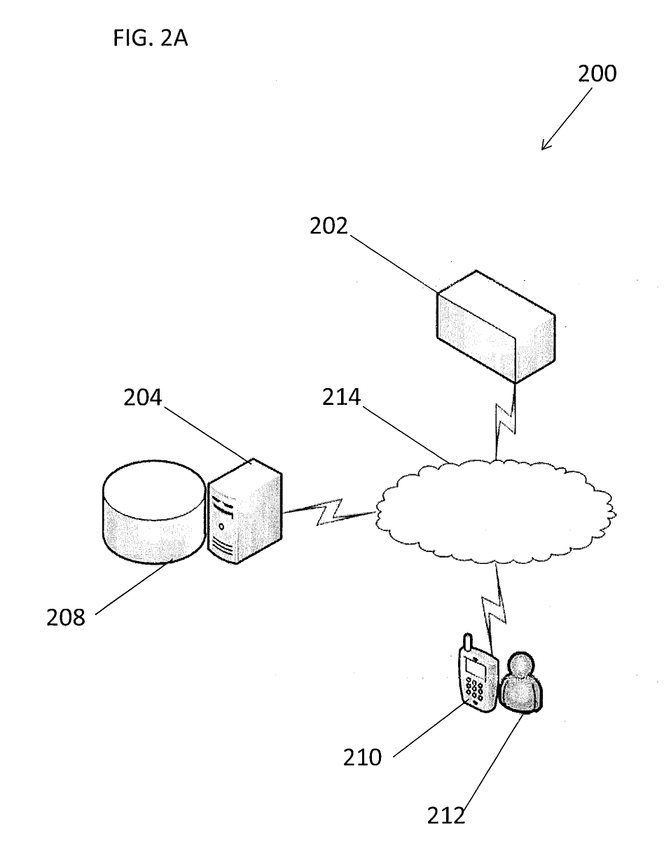

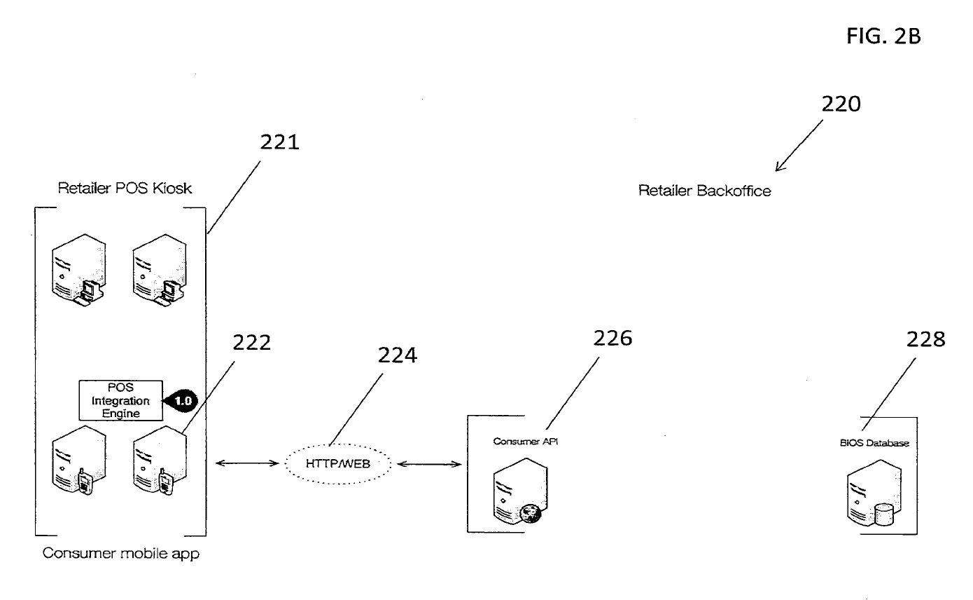

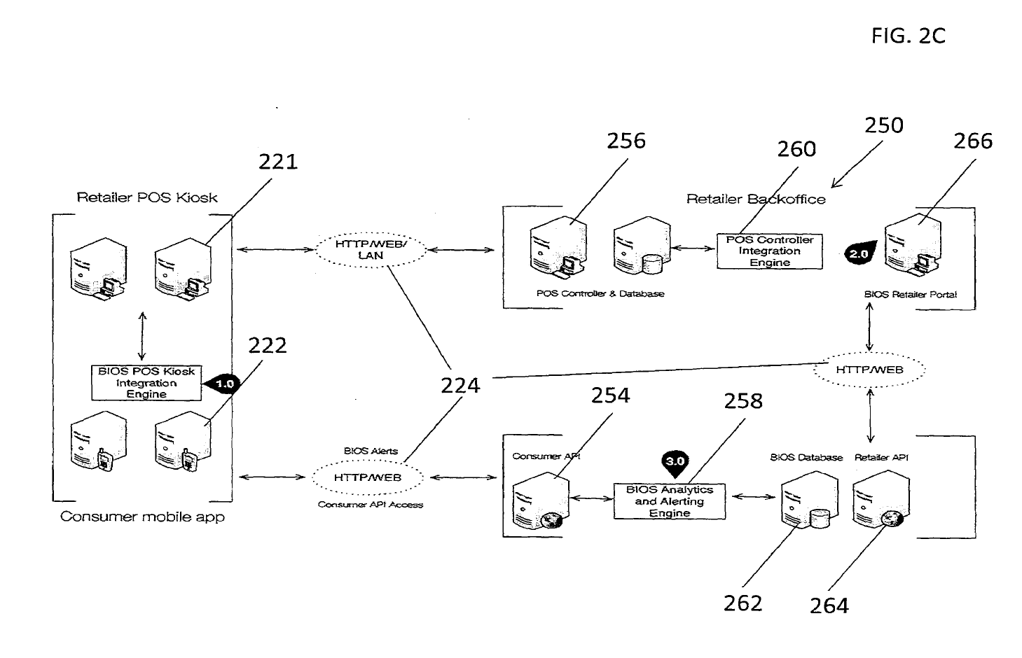

Referring now to FIG. 2A, there is shown at least one embodiment of the components of the system 200 for incentivized sales of consumer goods according to at least one embodiment of the present disclosure. System 200 comprises user device 210 (operated by user 212), server 204, database 208, computer network 214, and merchant system 202. For purposes of clarity, only one user device 210 and one computer network 214 are shown in FIG. 2. However, it is within the scope of the present disclosure that the system 200 may be any number of user devices 210 and computer networks 214 at one time.

The user device 210 may be configured to transmit information to and generally interact with a web services infrastructure housed on server 204. The user device 210 may include a web browser, mobile application, or other network connected software such that communication with the web services infrastructure on server 204 is possible over the computer network 214. User device 210 includes one or more computers, smartphones, tablets, computing devices, or systems of a type well known in the art, such as a mainframe computer, workstation, personal computer, laptop computer, hand-held computer, cellular telephone, or personal digital assistant. User device 210 comprises such software, hardware, and componentry as would occur to one of skill in the art, such as, for example, one or more microprocessors, memory systems, input/output devices, device controllers, and the like. User device 210 also comprises one or more data entry means (not shown in FIG. 2) operable by users of user device 210 for data entry, such as, for example, a pointing device (such as a mouse), keyboard, touchscreen, microphone, voice recognition, and/or other data entry means known in the art. User device 210 also comprises a display means (not shown in FIG. 2) which may comprise various types of known displays such as liquid crystal diode displays, light emitting diode display, and the like upon which information may be display in a manner perceptible to the user.

In at least one embodiment, the server 204 accesses the database 208 to store consumer purchase information, quantity-based item offers, product information and the like retrieved from the computer network 214 as described in the method 100. The server 204 is configured to carry out one or more of the steps of methods described herein,

The user device 210 is further configured to provide input to the server 204 to carry out one or more of the steps of the methods described herein. Server 204 comprises one or more server computers, computing devices, or systems of a type known in the art. Server 204 further comprises such software, hardware, and componentry as would occur to one of skill in the art, such as, for example, microprocessors, memory systems, input/output devices, device controllers, display systems, and the like. Server 204 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 2A, server 204 is shown and referred to herein as a single server. However, server 204 may comprise a plurality of servers, virtual infrastructure, or other computing devices or systems interconnected by hardware and software systems know in the art which collectively are operable to perform the functions allocated to server 204 in accordance with the present disclosure.

The database 208 is configured to store purchase information, consumer information, quantity-based item offers, product information, and other information. Database 208 is “associated with” server 204. According to the present disclosure, database 208 can be “associated with” server 204 where, as shown in the embodiment in FIG. 2, database 208 resides on server 204. Database 208 can also be “associated with” server 204 where database 208 resides on a server or computing device remote from server 204, provided that the remote server or computing device is capable of bi-directional data transfer with server 204, such as, for example, in Amazon AWS, Rackspace, or other virtual infrastructure, or any business network. In at least one embodiment, the remote server or computing device upon which database 230 resides is electronically connected to server 204 such that the remote server or computing device is capable of continuous bi-directional data transfer with server 204.

For purposes of clarity, database 208 is shown in FIG. 2, and referred to herein as a single database. It will be appreciated by those of ordinary skill in the art that database 208 may comprise a plurality of databases connected by software systems of a type well known in the art, which collectively are operable to perform the functions delegated to database 208 according to the present disclosure. Database 208 may comprise a relational database architecture or other database architecture of a type known in the database art. Database 208 may comprise one of many well-known database management systems, such as, for example, MICROSOFT's SQL Server, MICROSOFT's ACCESS, or IBM's DB2 database management systems, or the database management systems available from ORACLE or SYBASE. Database 208 retrievably stores information that are communicated to database 208 from user device 210, server 204, or merchant system 202.

Merchant system 202 may not be required and may reside on or be the same exact infrastructure as server 204 and database 208. Merchant system 202, in addition, may be a third party purchase solution configured to process transactions, store consumer information, and generally facilitate the sales of products at a physical store. In some embodiments, merchant system 202 integrated with server 204 such that server 204 calculates quantity-based item offers and merchant system 202 communicates purchases and pricing information to server 204 for the facilitation of such quantity-based item offers. It should be appreciated that each of server 204 and merchant system 202 may perform the same tasks or different tasks to facilitate quantity-based item offers herein. The system 200 shows disparate components for server 204 and merchant system 202 to highlight the use of third party point of sale solutions.

User device 210, server 204, and merchant system 202, all communicate via computer network 214. If database 208 is in disparate infrastructure from server 204, database 208 may communicate with server 204 via computer network 214. Computer network 214 may comprise the Internet, but this is not required.

Referring now to FIG. 2B, there is shown at least one embodiment of the components of the system 220 for incentivized sales of consumer goods according to at least one embodiment of the present disclosure. System 220 comprises a retailer point of sale kiosk 221, a point of sale integration engine 222, a computer network 224, a consumer application programming interface 226, and a database 228. Although FIG. 2B displays components of the system 220 as a single unit or, in some cases, multiple units, it should be appreciated that each component of the system 220 may be any number of units. In addition, although computer network 224 is shown in system 220 alone, it should be appreciated that each component of system 220 may communicate over any variety of computer networks.

Retailer point of sale (POS) kiosk 221 may be any system configured to receive a payment from a consumer in exchange for goods or after provision of a service. Such systems may be manned or unmanned, in brick and mortar stores or otherwise. These systems may include weighting scales, scanners, electronic and manual cash registers, touch screens, and any other hardware and software generally used to facilitate a transaction between a consumer and a business, including cloud-based point of sale solutions. These point of sale solutions may be configured to communicate with proprietary store systems through the Standard Interchange Language. For example, solutions may include offerings from Cybertill, Agilysys, and IBM.

In communication with the retailer POS kiosk is a POS integration engine 222. In the embodiment displayed in FIG. 2B, the POS integration engine 222 is within a consumer mobile application. In such an embodiment, at the time of purchase, the application integrates with the retailer POS kiosk to facilitate a payment in exchange for goods or services under the methods described herein. The POS integration engine may communicate with the retailer POS over near-field communication, RFID for identification purposes, scanning of a QR code, transmission of authentication credentials over a computer network, and other methods. In such an embodiment, the POS integration authenticates to the retailer POS using information stored in the database 228 that is accessible through the consumer application programming interface 226 over computer network 224.

For example, a user desiring to purchase a good under the methods described herein has a mobile application with the POS integration engine configured thereon installed on his smartphone. When the user approaches the retailer POS kiosk, the mobile application displays a QR code that is scanned by the retailer POS kiosk. This QR code uniquely identifies the user and authorizes the user to purchase under his account. When a purchase is performed, the retailer PUS kiosk transmits the purchase to the retailer backoffice which updates the database 228 and transmits the transaction to the user mobile application through the consumer application programming interface 226 and over web services on the computer network 224.

In another example, a user desiring to purchase a good under the methods described herein has a mobile application with the POS integration engine configured thereon installed on her smartphone. When the user approaches the retailer POS kiosk, she logs in directly through the mobile application with a username and password. In this example, the username and password are transmitted over web services through the computer network 224 to the consumer application programming interface 226 which verifies the user's identity at the database 228. Once authenticated, the user is prompted with available products to purchase through the methods described herein. In this example, the user selects a good for purchase and facilitates the transaction. Once the user submits the transaction at the mobile application, the database 228 is updated to reflect the purchase (through the consumer application programming interface 226 over the computer network 224) and the retailer POS kiosk 221 verifies the transaction occurred by accessing the database 228 through the back office. In this example, after the exchange, the user is authorized to leave the store with the purchased item.

In some embodiments, the mobile application and the POS integration engine 222 may utilize on device geo-location hardware and/or location services to determine the user's location to automatically populate which retailer the user is frequenting which allows inventory available for purchase to be displayed within the mobile application for ease of interaction at the retailer POS kiosk 221. In such an embodiment, the geo-location information may act as a factor in authentication of the user to the retailer POS kiosk 221 to only allow the user to make purchases through the methods described herein when the user is in close proximity to a store. In some embodiments, only inventory for purchase under the methods described herein in close proximity to the user will be populated in the mobile application based on the geo-location information obtained at the mobile device.

In some embodiments, the retailer POS kiosk 221 may be manned by an employee that scans items using the traditional retail purchase workflow. In such an embodiment, the POS integration engine 222 may authenticate the user at the end of the transaction but prior to payment to identify the user and alter the price of items for purchase under the methods described herein. For example, a user approaches the retailer POS kiosk with forty items in her shopping cart, five of which are pre-purchased inventory according to the methods described herein. In such an embodiment, the totality of the forty items are scanned by an employee (or self scanned by the user in a self service retailer POS kiosk). Prior to submitting payment, the user authenticates to her identity using the POS integration engine 222 which communicates the transaction information from the database 228 to the retailer POS kiosk 221. In such an embodiment, the retailer POS kiosk 221 removes the cost of the five items that were pre-purchased and updates the inventory in the database 228 to reflect the purchase occurred.

Of course, necessary authentication and communication of purchases between the POS integration engine 222, the database 228, and the retailer POS kiosk 221 may create a race condition for purchase repudiation. That is, two users may authenticate to the same account in two different lines at a retailer and make purchases at the exact same time with two different retailer POS kiosks. In this example, if the purchases are performed prior to inventory being removed at the database, the two purchases may be performed when only one is actually authorized. To prevent purchase repudiation, the POS integration engine 222 and authentication credentials may be specifically tied to the unique device identifier (UDID) of the smartphone. In other embodiments, the POS integration engine 222 may use a public key infrastructure with the bios database 228 to digitally sign purchase requests and authentication. In other embodiments, a user may be required to authenticate at the POS integration engine 222 at the start of a scanning process at the retailer POS kiosk 221 which locks the user's account at the database 228 until the transaction is completed.

Referring now to FIG. 2C, it is shown an architecture diagram of the components of a system 250 used in execution of the methods herein. As shown in FIG. 2C, the system 250 includes a retailer POS kiosk 221, a POS kiosk integration engine 222, computer networks 224, a consumer application programming interface 254, an analytics and alerting engine 258, a database 262, a retailer application programming interface 264, a point of sale controller and database 256, a point of sale consumer integration engine 260, and a retailer portal 266.

As shown in FIG. 2C, the system 250 includes a point of sale controller and database 256. In some embodiments, the POS controller and database 256 includes the necessary hardware and software to communicate with and receive transactions from one or more retailer POS kiosks 221 in a store. It should be appreciated that point of sale controllers and databases 256 are well known in the art. These technologies enable a retail store to receive all transactions within the store at one central location and store such information for inventory management and also to perform data analytics on consumers making purchases in the store. In these technologies, a consumer may be uniquely identified within the point of sale controller and database through the user's credit card information, shopper identification number, phone number, shopper identification card, or otherwise. These technologies may be equipped with marketing engines and other incentive programs to generate coupons uniquely tied to the shopper based on previous purchases and the like.

System 250 expands on the foregoing technology by adding a point of sale integration engine 26Q in communication with a publisher portal 266. In such an embodiment, the standard point of sale controller and database infrastructure 256 may communicate through a point of sale controller integration engine 260 with a publisher portal 266. The publisher portal 266 may be configured to allow retailers to create promotions for inventory within the point of sale controller and database 256 for purchase under the methods described herein. The portal 266 may be a standalone portal with distinct infrastructure from the point of sale controller and database 256 or the portal 266 may be configured as a module or add-on within the point of sale controller and database 256. In some embodiments, the portal 266 may be in geographically distinct infrastructure from the point of sale controller and database 256 (i.e. virtualized infrastructure in a cloud provider, a remote datacenter, etc.) and in communication with the point of sale controller and database 256 through a computer network.

The portal 266 may be configured to enable a retailer to create and monitor promotions for purchase of items under the inventory incentivized methods discussed herein. The portal 266 may further display the current inventory offered under the inventory incentivized methods herein, including quantity of items remaining on the shelf, presence of existing promotions, performance of various promotions, and a wizard or other workflow to allow the retailer to create new promotions. When the retailer selects functionality to create a new promotion, the portal 266 may receive a maximum quantity for purchase by the consumer at any specific time (i.e. ten gallons of milk), how long the promotion may run, and how long the consumer has to receive the total quantity of items purchased prior to the expiration of the promotion (i.e. user purchases ten gallons of milk on day 1 and has 14 more days to collect the ten gallons before expiration). In this end, after creation of the promotion, purchases for items under the incentivized program are handled through communication between the point of sale controller and database 256 and the integration engine 260.

System 250 further includes a database 262 and retailer application programming interface 264. In such an embodiment, the database 262 includes information associated with purchases under the incentivized program, available inventory under the incentivized program, and analytics information collected concerning users from the consumer mobile application (i.e. geo-location). In such an embodiment, the database 262 may communicate with the portal 266 through a retailer application programming interface 264 over a computer network through web services. The frequency of communication between the portal 266 and the database 262 may be configurable (i.e. once every fifteen minutes, hour, etc.).

Communication between the portal 266 and the database 262 enables the methods herein to push alerts to consumer mobile devices through a consumer application programming interface 254. Such alerts may occur when a new promotion is configured, a user's inventory for a specific promotion is exhausted, a price change occurs, an expiration time for a purchased promotion is approaching (i.e. one more day to receive remaining two gallons of purchased milk), and others.

In addition, the information stored within the database 262 may be associated with multiple stores running different promotions and in different industries. For example, a portal 266 may exist at a sporting goods store and another portal 266 may exist at a grocery store. In this example, the database 262 may include information associated with purchases from a single user at two different retail properties in two different industries. This additional information may allow for insights to be created from these differing industries. For example, a user purchasing a baseball bat and glove at the sporting goods store may be incentivized to purchase a sports drink at the grocery store. In this example, the database 262, after receiving information of purchase of the baseball bat and glove at the sporting goods store, may alert the user to a promotion of sporting drinks available at the grocery store.

Benefits of execution of the methods discussed herein and use of the systems discussed herein are discussed above. In addition, a store offering item-based promotions that are actively used by consumers prepares that store for inventory management with more accuracy than the traditional walk-up workflow. That is, if a store offers the purchase of six 12-packs of Mountain Dew at $4/pack good for six weeks and 100 users purchase that promotion, the store knows with certainty that it needs 600 12-packs of Mountain Dew over the next six weeks to handle the demand. Compare that knowledge with the traditional model where the store has limited predictability on how much Mountain Dew will be purchased by consumers in a six week period. The store in the traditional model may make guesses on consumer behavior from history or upcoming events (i.e. Super Bowl increasing demand), but the store is only able to make statistical guesses. With execution of the methods and implementation of the systems discussed herein, the store is able to know with certainty how much quantity of an item must be available within a given time period to handle the promotion purchases.

Referring now to FIG. 3A, it is shown a mockup of a graphical user interface 300 for a mobile application used in execution of the methods and systems described herein. As shown in FIG. 3A, the graphical user interface 300 is a home screen for finding and selecting quantity-based item offers. The graphical user interface includes sorting 304 and browsing 306 options and a main menus button 302. In some embodiments, when a user selects the main menus 302 option, the user is presented with the ability to select different areas of the mobile application, such as, for example, the home screen, a listing of quantity-based item offers available to the user, an explore feature, and a favorites feature. For example, the explore feature may enable the user to view a listing of quantity-based item offers in a geographic location or at an individual store (i.e. as shown in FIG. 3B) or a group of stores (i.e. as shown in FIG. 3C). The user may also select favorites in the mobile application by store or product that are retrieved with the favorites feature.

The graphical user interface 300 enables the user to sort the current view alphabetically, based on quantity-based item offers deadlines, price, and other ways. In addition, the user may browse by store or product for quantity-based item offers available.

The methods and systems described herein offer several unique consumer advantages over traditional programs. Those advantages would include, but are not limited to, the following:
1. No longer necessary to fumble around with paper coupons to get a one-time sale price;
2. Unlike a traditional layaway program where the consumer needs to pay some of the money now, there will be no cost to “save” these future buying opportunities;
3. Other than go through the checkout line and scan the consumers identifying data, there is nothing else for the consumer to do in order to take advantage of the sale;
4. The consumer can better manage their budgetary constraints;
5. The consumer can buy what they want and need at that time, and not be required to buy in bulk;
6. The consumer is not required to lug home massive quantities of goods that are heavy and hard to store;
7. The consumer can take advantage of future buying opportunities for certain perishables or other items with a short shelf life;
8. The consumer will have all of their information electronically available, which allows the consumer to search by brand, store, or location;
9. The consumer can be notified of unique offers on certain products that are available only to them;
10. The consumer can be rewarded for their loyalty.
11. The consumer can choose their store based on incentive sales available to them.

For the merchant and the manufacturer, the methods and systems described here offer at least the following advantages:
1. The merchant gets foot traffic assured in future visits, which means both store loyalty and increased sales when the consumer returns;
2. The merchant can promote in house store brands or other proprietary products;
3. The merchant can now effectively compete against the “big box” stores that offer low price volume buying;
4. The merchant can better understand the buying habits of its customer base;
5. The merchant can better understand the products which should be promoted to generate the greatest interest;
6. The manufacturer can now get an accurate count of promotional sales, since the information is gathered at checkout via scan down, and not estimated by a distributor who historically estimated the number of items to be sold and did a forward buy, which almost always is inaccurate and probably detrimental to the manufacturer;
7. The manufacturer can now better understand the impact and effect of its promotions;
8. Both the merchant and the manufacturer can offer “secret” promotion opportunities to its loyal purchasing base.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for incentivized sale and purchase of quantity based consumer goods at multiple purchase opportunities over extended period of time, the method comprising:
transmitting an offer to a consumer device, the offer comprising an item, price per item, a quantity, and a duration;
selling, through the consumer device, the offer to a consumer;
storing the consumer and the offer in a database;
uniquely identifying the consumer through the consumer device at a point of sale;
exchanging a number of the item with the consumer at the point of sale at the price per item, the number being less than or equal to the quantity;
reducing the quantity associated with the offer in the database by the number to a remaining quantity; and
honoring the offer at the point of sale for the duration at the remaining quantity.

2. The method of claim 1, wherein the identifying step is performed by scanning a QR code uniquely associated with the consumer at the point of sale.

3. The method of claim 1, wherein the consumer device is a smartphone equipped with geolocation services, the method comprising:
filtering a plurality of offers based on a geolocation of the consumer device to find the offer, the offer being within a geographic proximity to the consumer device.

4. The method of claim 1, wherein the exchanging step includes transferring money through the customer device over a computer network.

5. The method of claim 1, wherein the consumer is uniquely identified based at least in part on a unique identifier associated with the consumer device.

6. The method of claim 5, wherein the storing step includes storing the unique identifier in association with the offer and the consumer.

7. A system for incentivized sale and purchase of quantity based consumer goods at multiple purchase opportunities over extended period of time, the system comprising:
a database;
a consumer device;
a point of sale;
a server electronically coupled to the database, the server configured to transmit an offer to the consumer device, the offer comprising an item, price per item, a quantity, and a duration, sell the offer to a consumer at the consumer device, transfer the consumer and the offer to the database, uniquely identify the consumer through the consumer device at the point of sale, exchange a number of the item with the consumer at the point of sale at the price per item, the number being less than or equal to the quantity, reduce the quantity associated with the offer in the database by the number to a remaining quantity, and honor the offer at the point of sale for the duration at the remaining quantity.

8. The system of claim 7, wherein the server is further configured to identify the user by scanning a QR code uniquely associated with the consumer at the point of sale.

9. The system of claim 7, wherein the consumer device is a smartphone equipped with geolocation services.

10. The system of claim 7, wherein the server is further configured to filter a plurality of offers based on a geolocation of the consumer device to find the offer, the offer being within a geographic proximity to the consumer device.

11. The method of claim 7, wherein the server is further configured to exchange by transferring money through the customer device over a computer network.

12. The method of claim 7, wherein the consumer is uniquely identified based at least in part on a unique identifier associated with the consumer device.

13. The method of claim 12, wherein the server is further configured to store the unique identifier in association with the offer and the consumer in the database.

14. A computerized method for incentivized sale and purchase of quantity based consumer goods at multiple purchase opportunities over extended period of time, the method comprising:
configuring an offer at a publisher portal, the offer comprising an item, price per item, a quantity, and a duration;
receiving, at a point a sale, a request to purchase the item from a consumer;
identifying the consumer at the point of sale based on a consumer identifier;
associating the consumer identifier at the publisher portal with the offer, the offer being previously purchased by the consumer;
exchanging the item at the point of sale with the consumer based on the offer; and
logging a sale of the item, the consumer and the offer at the publisher portal.

15. The method of claim 14, further comprising:
associating the consumer, the offer, and a remaining quantity in a database, the remaining quantity being the same as the quantity; and
reducing the remaining quantity by one based on the logging step.

16. The method of claim 15, wherein the exchanging step is performed only if the remaining quantity is greater than zero.
